(19) United States
(12) Patent Application Publication
(10) Pub. No.: US 2012/0218399 A1
(43) Pub. Date: Aug. 30, 2012

(54) ELECTRONIC APPARATUS, CONTROLLER OF INDICATOR, AND CONTROL METHOD OF THE SAME

(75) Inventors: Tomofumi Miyamoto, Tokyo (JP); Kazuhiro Nakamura, Tokyo (JP)

(73) Assignee: KABUSHIKI KAISHA TOSHIBA, Tokyo (JP)

(21) Appl. No.: 13/276,716

(22) Filed: Oct. 19, 2011

(30) Foreign Application Priority Data
Feb. 28, 2011 (JP) 2011-042350

(51) Int. Cl. H04N 7/18

(52) U.S. Cl. 348/78; 348/E07.085

(57) ABSTRACT

According to one embodiment, an electronic apparatus includes a camera, an indicator, an eye-tracking module, and a first controller. The eye-tracking module is configured to recognize an eye of a user based on an image photographed by the camera. The first controller is configured to switch an indication of the indicator in accordance with whether the eye of the user is recognized.

### CROSS REFERENCE TO RELATED APPLICATIONS

This application is based upon and claims the benefit of priority from the prior Japanese Patent Application No. 2011-42350, filed on Feb. 28, 2011, the entire contents of which are incorporated herein by reference.

### FIELD

Embodiments described herein relate generally to an electronic apparatus, a controller of an indicator, and a control method of the same.

### BACKGROUND

In general, a personal computer and so on with a camera has an LED (Light Emitting Diode) indicating that the camera is activated. However, if the LED always emits light, the LED is too bright and it is difficult to see the display of the computer.

### BRIEF DESCRIPTION OF THE DRAWINGS

FIG. 1 is a perspective view of a personal computer 100 according to one embodiment.

FIG. 2 is a top view of the personal computer 100 and a user 200 thereof.

FIG. 3 is a schematic block diagram of the controller 11 in the display unit 20.

FIG. 4 is a flowchart showing processing operations of the controller 11.

### DETAILED DESCRIPTION

In general, according to one embodiment, an electronic apparatus includes a camera, an indicator, an eye-tracking module, and a first controller. The eye-tracking module is configured to recognize an eye of a user based on an image photographed by the camera. The first controller is configured to switch an indication of the indicator in accordance with whether the eye of the user is recognized.

Embodiments will now be explained with reference to the accompanying drawings.

In the present embodiment, a personal computer as a representative of electronic apparatuses will be explained as an example. Explanation of general personal computers will be omitted, and technical characteristics of the present embodiment will be mainly explained.

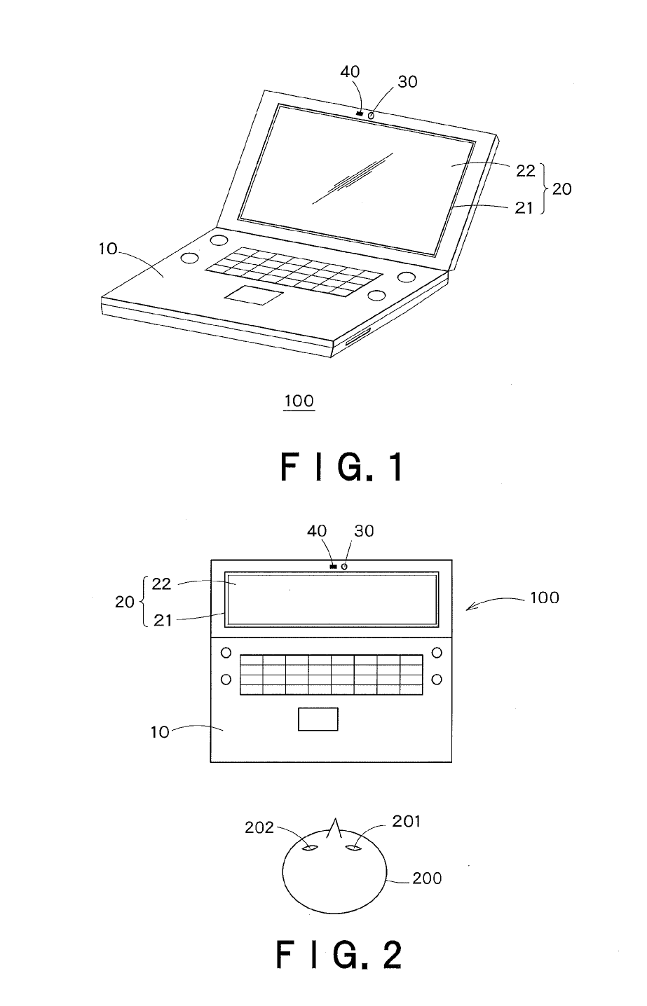

FIG. 1 is a perspective view of a personal computer 100 according to one embodiment, and FIG. 2 is a top view of the personal computer 100 and a user 200 thereof.

The personal computer 100 has a computer body 10, a display unit 20, a camera 30 and an LED (indicator) 40.

A CPU (Central Processing Unit), a memory and a hard disk drive are mounted in the computer body 10, and an optical disk drive is further provided thereon. The hard disk stores an optical disk reproducing program. By executing the program by the CPU, it is possible to reproduce the video signal and/or audio signal stored in an optical disk such as a DVD (Digital

Versatile Disk), HD DVD (High Definition DVD) or BD (Blu-ray Disk) inserted in the optical disk drive. Furthermore, it is also possible to reproduce the video signal and/or audio signal stored in the hard disk or in other recording media connected through USB (Universal Serial Bus) terminal.

In the present embodiment, the computer body 10 outputs multiple parallax images viewed from viewpoints different from each other to the display unit 20 so that the user 200 can see the image stereoscopically. When depth information is stored in the optical disk and so on in advance, the parallax images can be generated using the stored depth information. When the depth information is not stored, the parallax images can be generated based on the depth information calculated by analyzing the video signal. At least two parallax images for the right eye 201 and the left eye 202 are generated. In order to display more natural stereoscopic image, nine parallax images viewed from viewpoints arranged on the horizontal direction may be generated.

Furthermore, the computer body 10 has a controller 11 for controlling the display unit 20 and the LED 40 (not shown in FIGS. 1 and 2), which will be described below. The controller 11 is stored in the hard disk as a computer program, for example.

The display unit 20 has a liquid crystal panel (display) 21 and a filter (output module) 22. The liquid crystal panel 21 displays, at the same time, the multiple parallax images reproduced by the optical disk reproducing program. In an autostereoscopic display, the image may not be seen stereoscopically depending on the user's position. Therefore, the filter 22 is arranged facing the liquid crystal panel 21, and the filter 22 outputs the parallax image displayed on the liquid crystal panel 21 toward a specific direction. That is, the filter 22 outputs one of the multiple parallax images toward the right eye 201 of the user 200 and another one of the multiple parallax images toward the left eye 202 of the user 200. The right eye 201 of the user 200 and the left eye 202 thereof see different parallax images, thereby the user 200 can see the image stereoscopically. The outputting direction of the filter 22 can be controlled by the controller 11.

The camera 30 is arranged above the display unit 20, for example. In order to recognize the position of the user's eye, the camera 30 photographs a predetermined area and provided a photographed image to the controller 11. It is preferable that the camera 30 has over one mega pixels to recognize the eyes. Furthermore, the hard disk in the computer body 10 can store the image photographed by the camera 30.

The LED 40 is arranged near the camera 30 and indicates that the camera 30 is activated. The LED 40 is controlled by the controller 11.

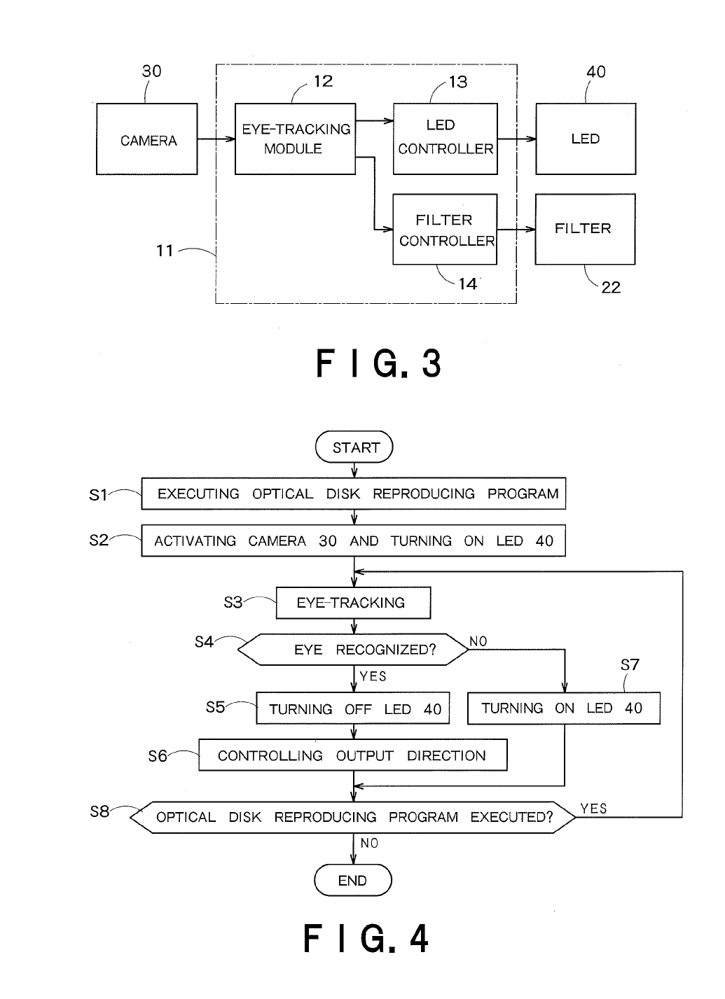

FIG. 3 is a schematic block diagram of the controller 11 in the display unit 20. The controller 11 has an eye-tracking module 12, an LED controller (first controller) 13, and a filter controller (second controller) 14.

The eye-tracking module 12 tracks the eyes of the user 200 based on the video photographed by the camera 30. Then, the eye-tracking module 12 provides a signal indicative of whether or not the eyes of the user 200 can be recognized to the LED controller 13, and when recognized, a signal indicative of the position of the eyes of the user 200 to the filter controller 14. The LED controller 13 turns the LED 40 on with the activation of the camera 30, and after that, turns the LED 40 off when the eyes of the user 200 can be recognized. The filter controller 14 controls the filter 22 so that one of the multiple parallax images is outputted to the right eye 201 of the user 200 and another one of them is outputted to the left eye 202 of the user 200.

FIG. 4 is a flowchart showing processing operations of the controller 11.

When the optical disk reproducing program is executed and the multiple parallax images are displayed on the liquid crystal panel 21 (Step S1), the camera 30 is activated in order to recognize the position of the eyes of the user 200, and the LED controller 13 turns the LED 40 on (Step S2). Because of this, the user 200 can know that the camera 30 is activated. The image photographed by the camera 30 is provided to the eye-tracking module 12 in the controller 11, and the eye-tracking module 12 tracks the eyes of the user 200 based on the image (Step S3).

When the eye-tracking module 12 can recognize the eyes of the user 200 (Step S4—YES), the LED controller 13 turns the LED 40 off (Step S5). If the LED 40 has already been turned off, the status is kept. Furthermore, the filter controller 14 controls the output direction of the filter 22 so that the user 200 can see the image on the liquid crystal panel 21 stereoscopically (Step S6). If the LED 40 keeps lighting, the LED 40 is too bright, and thus, it may be difficult for the user 200 to see the image. On the other hand, in the present embodiment, since the LED 40 is turned off, the user 200 can see the image comfortably. Additionally, because the user 200 in front of the personal computer 100 sees the stereoscopic image and knows that the camera 30 is activated, it is no problem to turn the LED 40 off. Moreover, the user 200 also can know that image is displayed stereoscopically by the turned-off LED 40.

Contrarily, immediately after activating the camera 30 or when the user 200 moves away, the eye-tracking module 12 cannot recognize the eyes of the user 200 (Step S4—NO). Then, the LED controller 13 turns the LED 40 on (Step S7). If the LED 40 is on, the status is kept. Because of this, the user 200 can know that the image is not displayed stereoscopically not because of the defect of the image but because the positions of the eyes are not recognized by the camera 30. Furthermore, when the user 200 moves away from the personal computer 100 temporarily, third person around the personal computer 100 can know that the camera 30 is activated from the lighting LED 40. Because the third person does not see the image, it is no problem that the LED 40 is lighting.

Even when the eyes of the user 200 can or cannot be recognized, the controller 11 continues the above processing operations (Steps S3 to S7), while the optical disk reproduction program is executed (Step S8—YES).

As stated above, in the present embodiment, the eye-tracking module 12 tracks the eyes of the user 200, and when the eye-tracking module 12 can recognize the eyes, the LED 40 is turned off. Therefore, the user 200 can see the image comfortably.

In the present embodiment, the personal computer 100 has been explained as an example. However, indicator such as the LED and output module such as the filter can be controlled similarly in other electronic apparatuses such as televisions, cellular phones having a display.

Furthermore, an example has been explained where the optical disk is reproduced to display the stereoscopic image. However, when other application for displaying the stereoscopic image is executed, the LED and the filter can be controlled similarly. Additionally, not only when an application for displaying a stereoscopic image is executed, but when applications such as television telephone which use a camera are executed, the LED can be turned off when the user's eye is recognized. Because of this, the user can directly see the display without being disturbed by the LED. In cases of electronic apparatuses not displaying stereoscopic images, the filter 22 and the filter controller 14 in the controller 11 can be omitted.

The filter 22 for displaying the stereoscopic image is, for example, a liquid crystal filter, and the filter 22 can control the output direction from the liquid crystal panel 21 by deflecting the liquid crystal material. Other manners can be also applicable. Furthermore, in Step 5 of FIG. 4, an example is shown where the LED 40 is turned off. However, it is enough to vary the displaying configuration depending on whether or not the user's eye is recognized. For example, when the user's eye is recognized, the brightness of the LED 40 can be controlled to be lower, or the color thereof can be controlled to be less appealing color comparing to when the user's eye is not recognized. Additionally, when the user's eye is recognized, a shutter is closed in order to shield the light emitted by the LED 40 while the LED 40 is kept on.

At least a part of the controller 11 explained in the above embodiments can be formed of hardware or software. When the controller 11 is partially formed of the software, it is possible to store a program implementing at least a partial function of the controller 11 in a recording medium such as a flexible disc, CD-ROM, etc. and to execute the program by making a computer read the program. The recording medium is not limited to a removable medium such as a magnetic disk, optical disk, etc., and can be a fixed-type recording medium such as a hard disk device, memory, etc.

Further, a program realizing at least a partial function of the controller 11 can be distributed through a communication line (including radio communication) such as the Internet etc.

Furthermore, the program which is encrypted, modulated, or compressed can be distributed through a wired line or a radio link such as the Internet etc. or through the recording medium storing the program.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fail within the scope and spirit of the inventions.

1. An electronic apparatus comprising:
a camera configured to capture an image;
an indicator;
an eye-tracking module configured to detect a portion of the image indicative of an eye of a user; and
a first controller configured to switch a state of the indicator based on whether the eye of the user is detected.

2. The apparatus of claim 1 further comprising:
a display configured to display a plurality of parallax images;
an output module configured to output each of the parallax images in a specific direction; and
a second controller configured to control an output direction of the output module based on a position of the eye when the eye of the user is detected in such a manner that the parallax images are seen stereoscopically.

3. The apparatus of claim 1, wherein the first controller is further configured to:
turn on the indicator when the eye of the user is not detected, and
turn off the indicator, decrease a brightness of the indicator, or cause the indicator to emit a first color when the eye of the user is detected, wherein the indicator emits a second color when the eye of the user is not detected.

4. The apparatus of claim 1, wherein the first controller is further configured to turn the indicator on when the camera is activated, and to subsequently switch the state of the indicator based on whether the eye of the user is detected.

5. The apparatus of claim 1, wherein the apparatus comprises a personal computer.

6. A control method of an indicator, the method comprising:
detecting a portion of an image indicative of an eye of a user based on the image photographed by a camera; and
switching a state of an indicator based on whether the eye of the user is recognized.

7. The method of claim 6, further comprising controlling an output direction of each of a plurality of parallax images displayed on a display based on a position of the eye when the eye of the user is detected in such a manner that the parallax images are seen stereoscopically.

8. The method of claim 6, further comprising:
turning on the indicator when the eye of the user is not detected, and
turning off the indicator, decreasing a brightness of the indicator, or causing the indicator to emit a first color when the eye of the user is detected, wherein the indicator emits a second color when the eye of the user is not detected.

9. The method of claim 6 further comprising turning the indicator on when the camera is activated and subsequently switching the state of the indicator based on whether the eye of the user is recognized.

10. A controller of an indicator, the controller comprising:
an eye-tracking module configured to detect a portion of an image indicative of an eye of a user based on the image photographed by a camera; and
a first controller configured to switch a state of an indicator based on whether the eye of the user is detected.

11. The controller of claim 10, further comprising a second controller configured to control an output direction of each of a plurality of parallax images displayed on a display based on a position of the eye when the eye of the user is detected in such a manner that the parallax images are seen stereoscopically.

12. The controller of claim 10, wherein the first controller is further configured to:
turn on the indicator when the eye of the user is not detected, and
turn off the indicator, decrease a brightness of the indicator, or cause the indicator to emit a first color when the eye of the user is detected, wherein the indicator emits a second color when the eye of the user is not detected.

13. The controller of claim 10, wherein the first controller is further configured to turn the indicator on when the camera is activated, and to subsequently switch the state of the indicator based on whether the eye of the user is detected.
